(19) United States
(12) Patent Application Publication
(10) Pub. No.: US 2016/0121640 A1
(43) Pub. Date: May 5, 2016

(54) FLAT CONCAVE MICRO LENS FOR SECURITY AS AN INTEGRATED FOCUSING ELEMENT

(71) Applicant: LUMENCO, LLC, ENGLEWOOD, CO (US)

(72) Inventor: MARK A. RAYMOND, LITTLETON, CO (US)

(21) Appl. No.: 14/696,727

(22) Filed: Apr. 27, 2015

Related U.S. Application Data
(60) Provisional application No. 62/074,695, filed on Nov. 4, 2014.

(51) Int. Cl. B42D 25/328; B42D 25/45

(52) U.S. Cl. CPC B42D 25/328; B42D 25/45

(57) ABSTRACT

An optical security element for currency or other products. The security element includes a film or substrate and an image element provided on an exterior surface of this substrate. The substrate is formed of a transparent material. A concave focusing element is formed upon the opposite side or surface of the substrate, with a focusing substrate with a first side abutting the substrate and a second side facing away from the substrate. Concave lenses are provided in this second side of the concave focusing element. The optical security element includes an outer layer formed of a transparent material that is applied so as to cover the concave focusing element and to “fill in” the concave lenses. The materials, e.g., a polyester or polypropylene, are chosen for the optical security element such that the concave focusing element has an index of refraction that is lower than that of the outer layer.

### CROSS-REFERENCE TO RELATED APPLICATIONS

This application claims the benefit of U.S. Provisional Application No. 62/074,695, filed Nov. 4, 2014, which is incorporated herein by reference in its entirety.

### BACKGROUND

1. Field of the Description

This description is generally directed toward products such as polymer and other bank notes (or currency) with optical security features, and, more particularly, to a new configuration for an optical security element for products that provides flat outer surfaces and can have a thickness matching the adjacent portions of the product while providing focusing on security images.

2. Relevant Background

There are many products presently manufactured and distributed with optical security features so as to try to limit copying and counterfeiting. One of the most prevalent of these is currency of a country used daily in commerce. Other examples include tags or labels provided on clothing and other consumer items and credit and bank cards. It is desirable to provide optical security features to these and other products with minimal cost while also providing high levels of anti-counterfeiting protection.

With regard to protecting currency from copying, polymer bank notes or currency are made from a plastic or polymer such as biaxially oriented polypropylene (BOPP), blown propylene film, or the like. A growing number of countries are considering or even converting from paper to polymer bank notes, with at least eight countries having fully converted to polymer bank notes by 2014. Lower costs are one reason for this conversion as the polymer substrate or body of the bank note makes this currency more durable and longer lived. However, anti-counterfeiting is another key reason that many countries are converting to polymer bank notes.

Security features that are provided on paper can also be provided on polymer bank notes. Additionally, though, new security features that cannot be provided with paper currency can be provided with polymer bank notes because the substrate or body of the bank notes can be provided to be transparent (herein, “transparent” is intended to mean translucent to transparent to light). Hence, a transparent window may be provided that is used to display a security image that allows the bank note to be authenticated. An optical security feature may take the form of a lens or lens array (e.g., a lenticular lens array, a diffraction grating, or the like) that is used to display an image printed on an opposite side of the transparent substrate (e.g., an interlaced image when the lens array is a lenticular lens array). The displayed or visible image may be a three dimensional (3D) image, an image that is animated with movement of the bank note (or with differing viewing angles), an image provided by a full volume pixel map or moiré pattern, and/or provide other optical effects available through the use of lenticular, diffraction, and other optical technologies. With the use of such optical security features, polymer bank notes are very difficult to counterfeit as the optical security features cannot simply be copied using scanning, photocopying, and other techniques used with some paper bank notes.

In many polymer bank notes, the security or anti-counterfeiting features are provided by a lens or lens array that is cast or embossed on the front or back of the bank note (or its transparent substrate or body) and by a corresponding image (e.g., a printed, embossed, holographic, or other image visible through the lens or lens array, which may be considered the image element or component) provided on the reverse side of the bank note. An ongoing challenge, however, is to provide adequate focusing with the lens or lens array onto the image to provide an in-focus image to a viewer through the lens or lens array. Presently, an existing design for the optical security feature provides lenses that are relative wide and focus at a point well beyond the reverse side of the bank note substrate where the image is provided such that the displayed or produced image appears out-of-focus to a viewer inspecting the authenticity of the bank note.

In this regard, most polymer bank notes have a thickness in the range of 65 to 100 microns. For example, some bank notes have a substrate or body that is 75 microns thick while ink and/or other deposited materials on its outer surfaces increase the overall thickness by about 10 to 20 microns such that the overall thickness of the bank note is 85 to 95 microns. The material thickness of the bank note substrate is relatively fixed for each series of bank notes for a country, and a requirement for each optical security feature is that the thickness of the note at the optical security feature match that of the other portions of the bank note (e.g., the optical security feature that is made up of the lens array, the substrate thickness, and the ink or other material used to provide the image on the reverse side should be equal to or less than the adjacent portions of the note made up of the substrate or body along with layers of ink and/or other deposited materials adjacent to one or both sides of the lens array and its corresponding image).

There remains a need for improved optical security features for products such as polymer bank notes that provide enhanced or improved focusing by the lens or lens array onto the reverse surface of the bank note or other substrate and the image element provided on this reverse surface. Preferably, bank notes and other products (or product labels) with these improved optical security features would be inexpensive to manufacture while providing an acceptable overall thickness along the length of the note or product/label substrate.

### SUMMARY

The inventor recognized that micro lenses are used for magnifying moiré patterns, interlaced printed images, and holographic elements in security elements. These security elements have been used in currency and products (or their branding instruments) for at least the past several years. The typical profile (or side/end view) of the arrays of micro lenses is convex such that the lenses extend outward from an exterior surface of the security element, and this external or outward-extending profile can be problematic for several reasons. First, these security elements can be copied, such as by molding, because of the external or exposed profile of the lenses, which can facilitate counterfeiting of the security element and, hence, the products upon which they are provided including currency. Second, the arrays of micro lenses typically cannot be covered (e.g., to provide a protected and/or flat external surface) using an adhesive or gluing because when the adhesive “fills in” or covers the exterior surface of the security element the lenses no longer function properly, e.g., focusing is distorted or otherwise negatively impacted.

Briefly, an optical security element is taught that generally includes a carrier film or substrate, and an image element can be provided on an exterior surface of this substrate, which is formed of a transparent material such as PET, polypropylene, or the like. A concave focusing element is formed (e.g., cast or embossed) upon the opposite side or surface of the substrate, and this focusing element has a focusing substrate with a first side abutting the substrate and a second side facing away from the substrate. An array of concave lenses or structures are provided in this second side of the concave focusing element, which is also formed of a transparent material.

The optical security element further includes an outer layer formed of a transparent material that is provided or applied so as to cover the concave focusing element and to “fill in” the concave lenses. In some embodiments, the materials are chosen for the components of the optical security element such that the concave focusing element has an index of refraction that is lower than that of the outer layer with its lens filling portions (or fill portions or fillers). The material of the substrate may also be formed of a material with an index of refraction that is higher than that of the concave focusing element (e.g., to match or be lower than that of the outer layer), but some embodiments may use a film or substrate material with an index of refraction that is the same or lower than the material of the concave focusing element.

More particularly, an apparatus for use as an optical security element is taught, such as may be used as an integral part of a polymer bank note or as part of a product (e.g., a branding tag used to show authenticity of retail goods). The apparatus includes a planar substrate with a first side and a second side opposite the first side, and the planar substrate is formed using a transparent material with a first index of refraction. The apparatus also includes an image element provided on the first side of the planar substrate (e.g., a printed image or ink layer). Further, the apparatus includes a concave focusing element with a focusing substrate with a first side abutting the second side of the planar substrate and with a second side including a plurality of concave lenses (or an array of concave structures). In practice, the concave focusing element can be formed using a transparent material with a second index of refraction. Still further, the apparatus includes an outer layer with fill portions or “fillers” used to fill in the concave lenses. The outer layer may also include a covering film over the fill portions. The outer layer may be formed using a transparent material with a third index of refraction. In use, light striking a planar exterior surface of the covering film is focused through the outer layer, the concave lenses, and the planar substrate onto the image element.

In some embodiments, the second index of refraction is lower than the third index of refraction (e.g., the concave focusing element is made of a lower index material than the outer layer and its fill portions). Further, it may be useful that the first index of refraction matches the third index of refraction or that the first index of refraction is lower than the second index of refraction. To this end, the first index of refraction may be in the range of 1.35 to 1.8 (e.g., be about 1.6). In other cases, the second index of refraction is in the range of 1.34 to 1.7. For example, the second index of refraction can be less than 1.5 and the lenses each may have a chord width and a radius of less than 10 microns. In other embodiments, the third index of refraction is in the range of 1.4 to 2.3 (such as about 1.6).

It may also be useful to have the second index of refraction be lower than the third index of refraction by at least 0.13 such as by having the second index of refraction be lower than the third index of refraction by an amount in the range of 0.20 and 0.35. In some implementations, each of the lenses has a chord width in the range of 5 to 100 microns, and the third index of refraction is higher than the second index of diffraction by at least 0.13. In the same or other implementations, a combined thickness of the planar substrate, the concave focusing element, and the outer layer is between 10 and 200 microns.

### BRIEF DESCRIPTION OF THE DRAWINGS

FIG. 1 illustrates a schematic side view (or functional block drawing) of a product or item (such as product branding label, a credit/debit card, a polymer bank note, or the like) including an optical security element (or feature or assembly) of the present description;

FIG. 2 is a top view of a polymer bank note with an optical security assembly of the present description similar to that provided/shown in the product of FIG. 1 but with an array of circular, concave lenses rather than linear or elongated concave lenses as shown in FIG. 1;

FIG. 3 is a partial sectional view of an optical security element or assembly useful with a variety of products such as currency or bank notes;

FIG. 4 shows results of a ray tracing for one embodiment or prototype/model of an optical security element of the present description;

FIG. 5 shows results of a ray tracing for another embodiment or prototype/model of an optical security element of the present description; and

FIG. 6 shows results of a ray tracing for yet another embodiment or prototype/model of an optical security element of the present description.

### DETAILED DESCRIPTION

Briefly, the present description is directed toward products, such as branding labels, credit/debit/bank cards, and polymer bank notes, that are fabricated so as to include an optical security element (or feature or assembly), which is designed to provide enhanced optical focusing using concave lenses. Further, the lenses or lens array are covered to protect the lenses, to limit ready copying to limit counterfeiting, and to provide a flat or planar exterior surface level with adjacent surfaces.

To this end, the optical security assembly includes a carrier film or substrate (transparent product body, in some cases). An image element, e.g., a printed ink layer, is provided on a first surface of the carrier film/substrate, and the optical security assembly further includes an array or plurality of micro lenses on a second surface of the carrier film/substrate opposite the image element. The micro lenses are provided in an optical material layer deposited upon the second surface, and the micro lenses are concave (formed as recessed surfaces in this optical material layer). The lenses and the film/focusing substrate of the deposited optical material may be thought of as a “concave focusing element.” The optical security assembly also includes an upper or outer layer made up of fillers or fill portions within each concave lens and, optionally, a covering film or substrate built up over the fillers/fill portions to provide further protective material for the lenses and/or for further enhancing focusing functions of the optical security assembly.

With regards to providing focusing onto the image element, the three components of the assembly may have equal or substantially equal (e.g., with 10 percent) refractive indexes. In other cases, though, two or more of the components will have differing refractive indexes. For example, the fillers or fill portions and, if provided, covering film may be formed of a material with an index of refraction that is greater than the index of refraction of the material used to provide the array of concave lenses and their support/focusing substrate (e.g., portion of material deposited to form the concave lenses on the carrier film surface). Then, the carrier film/substrate may have the same index of refraction as the fill portions and covering film or a different index of refraction that also is higher than that of the material used to provide the array of concave lenses and their support/focusing substrate. In other embodiments, though, the carrier film may have the same or a smaller index as that of the concave focusing element. However, by moving from the lower index into the higher index, the light focuses more rapidly than in embodiments where the carrier film has the same index as the concave focusing element. In this manner, the required thickness of the overall optical security assembly can be less than if the carrier film were to have an index of refraction that were the same or less than that of the concave focusing element.

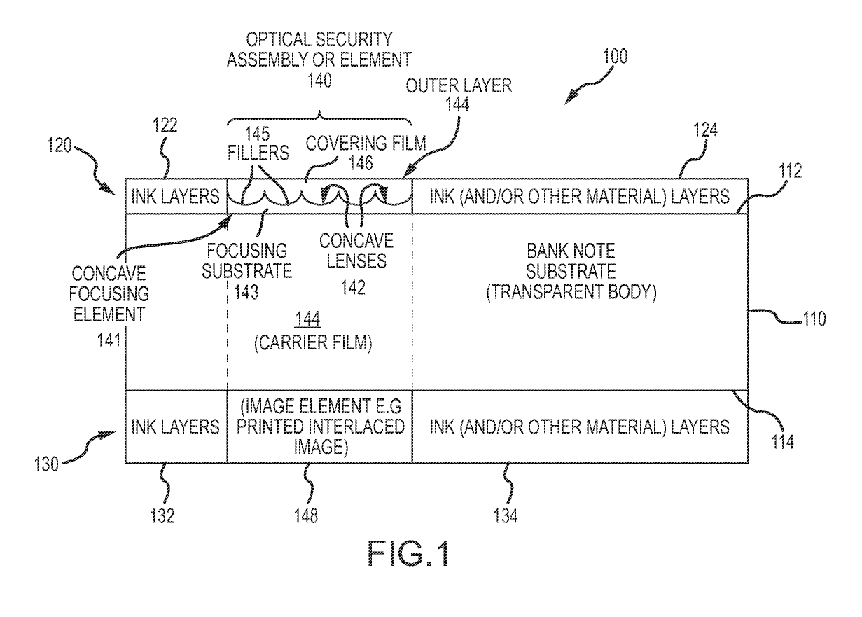

Many products or items may be fabricated to include an optical security element or assembly of the present description, but it may be useful to illustrate one particular product to show one intended and beneficial use. FIG. 1 illustrates schematically (or with a functional block-type drawing) a polymer bank note 100 of the present description. The bank note 100 is “polymer” in that it includes a body or substrate 110 that is formed of a transparent (e.g., translucent to transparent to light) plastic or polymer such as, but not limited to, a polypropylene such as biaxially oriented polypropylene (BOPP). The note substrate 110 is formed from a thin sheet of the polymer or plastic such that the body is planar with first and second opposite sides or surfaces 112, 114, with many countries having currency that is rectangular in shape that is 2 to 3 inches in width by 4 to 6 inches in length. The substrate 110 is “thin” in that it typically will have a thickness (as measured between sides/surfaces 112 and 114) of about 70 to 85 microns with 75 microns being a common thickness for the transparent substrate 110.

The bank note 100 further includes materials including layers of ink and other compounds to provide imagery and information associated with the currency definition or design for the country. As shown, the note 100 includes an upper currency image stack 120 and a lower currency image stack 130 that are used to display imagery and data associated with the front and back of a particular currency run, e.g., the imagery may differ for each denomination of a country's currency and the imagery may be updated periodically (such as to show a different country leaders image). The upper currency image stack 120 is shown to include first and second sets of ink (and/or other material) layers 122 and 124, and, likewise, the lower currency image stack 130 is shown to include first and second sets of ink (and/or other material) layers 132 and 134. The layers 122, 124, 132, 134 may include a base layer (e.g., a layer of white ink) followed by several other layers to print differing colors of an image.

The techniques for applying the image stacks 120, 130 are well known in the currency industry and, hence, are not explained in detail herein. For this description, it is more relevant that the ink layers 122, 124, 132, 134 increase the overall thickness of the bank note, and this build up thickness can be used to provide a concave focusing element 141 on one side 112 of the note substrate 110 and an image element (e.g., layers of ink providing a printed interlaced image or other imagery) 148 on the opposite or second side 114 of the substrate 110 without bumps or bulges that could negatively affect later use and processing of the bank note 100 and without an exposed profile/surface that could readily be copied/counterfeited. For example, the thickness of the ink layers 122, 124 (and also ink layers 132, 134) may be in the range of 7 to 25 microns with a thickness in the range of 10 to 20 microns and, in some cases, 12 to 18 microns being common in polymer bank notes presently in production.

As discussed above, it is desirable to design the bank note 100 such that any security features (including that of the optical security assembly or element 140) are provided without increasing the overall thickness of the note 100 and without providing a bulge or bump at the location of any of the security features. To this end, the bank note 100 is shown to include an optical security element or assembly 140 that is adapted, at least in this non-limiting example, to have an overall thickness that matches or is less than the overall thickness of the note 100 (e.g., thickness of the substrate 110 and ink layers 120, 130). Further, the optical security assembly 140 is adapted to provide improved focusing, e.g., in-substrate focusing rather than providing focusing that is outside the substrate 110 or similar focusing abilities to those provided presently with significantly thicker assemblies.

Particularly, the optical security assembly 140 includes a concave focusing element 141 attached to or, more typically, formed upon the first or upper side (or surface) 112 of the note substrate 110. In some cases, the concave focusing element 141 is cast or formed of the same material as the substrate 110, such as a transparent plastic or polymer (e.g., polypropylene or the like), but, in other cases, it is desirable to use a lower index of refraction material (relative to substrate 110) and the concave focusing element 141 is deposited such as with ultraviolet (UV) casting onto surface 112 of the substrate 110. The concave focusing element 141 is made up of a plurality of concave lenses (or an array of concave micro lenses) 142 such as concave lenticules (or other concave elongated/linear lenses), as shown in FIG. 1, that may have a circular, elliptical, hexagonal, square, or other cross-sectional shape or arrays of micro lenses with circular, hexagonal, square, or other bases. These lenses 142 are concave rather than the typical convex lenses used in many security features and provided as recessed surfaces in the exposed surface of the concave focusing element 141 (e.g., face away from or outward from the substrate 110). The concave focusing element 141 also includes a focusing substrate or lens support film 143 disposed or sandwiched between the lenses 142 and the surface 112 of the substrate 110 (e.g., provided by the optical focusing material deposited upon the surface 112 to form the array of concave lenses 142).

The optical security assembly 140 further includes an outer layer 144 including a plurality of fillers or fill portions 146, which are formed by applying material over the concave focusing element 141 so as to fill in each of the concave lenses 142. In some embodiments, the outer layer 144 only includes the fillers or fill portions 146, but, as shown, other embodiments will also include additional covering material in the outer layer 144 to provide a covering film 146. For example, it may be desirable to provide material over the lenses 142 to provide a covering film 146 with an outer/exterior surface that is flat or planar and that is level or about level with the outer/exterior surfaces of the ink stacks 122, 124 (or ink layer 120) to avoid bumps or dips in the note 100 where the optical security element 140 is provided. The outer layer 144 may be formed of a transparent material such as a polypropylene with similar optical characteristics including an index of refraction as that of the concave focusing element 141 and/or the substrate 144. However, the outer layer 144 may also be provided with material having a higher index of refraction than the concave focusing element 141, as will be explained in greater detail below.

The optical security assembly 140 also includes an image element 148, which may be a layer of ink providing a printed interlaced image such as by interlacing of images corresponding with the concave lenticules/lenses 142 of concave focusing element 141, and the image element 148 is provided on the second or lower side 114 opposite the lenses 142. The optical security element or assembly 140 further is shown to include a portion or segment 144 of the substrate 110 (e.g., a carrier film) that is sandwiched or positioned between the lenses 142 of the concave focusing element 141 and the image element 148. The lenses 142 of the focusing element 141 are configured (as discussed below) so as to focus through the substrate portion or carrier film 144 onto the back or second side 114 and the image element 148 provided there (or slightly in front of or behind the image element 148). The concave focusing element 141 is shown to be positioned in the gap or space between the ink layers 122 and the ink layers 124 while the image element 148 is positioned in the gap or space between the ink layers 132 and the ink layers 134, with portions of the image element (such as a slice or stripe of an interlaced image) 148 being aligned or registered with one (or more) of the lenses 142 of the concave focusing element 141.

In some cases, the lenses 142 are configured to have a height or sag, when combined with the thickness of the outer layer 144, that is equal to or less than the thicknesses of the adjacent ink layers 122, 124. Typically, the sets of ink layers 122 and 124 have substantially equal thicknesses, and these thicknesses may fall within the range of 7 to 25 microns, 10 to 20 microns, or 12 to 18 microns. The height or sag of the lenses 142 is measured from a line extending across the peaks between the lenses 142 (or chord of the lenses 142) to the bottom or deepest portion of the lenses 142 (or top of an arc of a lens 142), and the height or sag of the lenses 142 is set to match or be less than the thickness of layers 122, 124. For example, the ink layers 122, 124 may provide a buildup or thickness in the range of 12 to 18 microns such as 15 microns, and the height or sag of the lenses 142 would be limited to 15 microns so that the overall thickness of bank note 100, even with the addition of outer layer 144 over the lenses 142 and focusing substrate 143, does not exceed that defined by the ink layers 122, 124 combined with the substrate thickness and ink layers 132, 134.

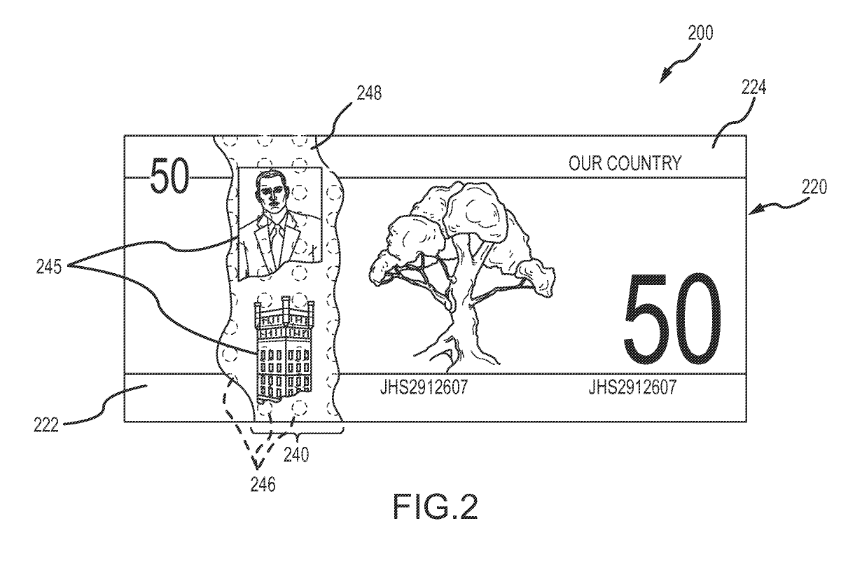

FIG. 2 illustrates a top view of an exemplary polymer bank note 200 fabricated according to the present description with an optical security element or assembly 240 that provides focusing through the use of filled-in concave lenses 246 of a concave focusing element. The bank note 200 includes an optical security assembly 240 with an array or plurality of concave lenses 246 that are covered and/or filled in by an outer layer 248 of transparent material (e.g., material with the same or, more typically, a higher index of refraction than the material providing the lenses 246). In this embodiment of note 200, the concave lenses 246 are round-based lenses arranged in an array of rows and columns rather than the linear lenses 142 of FIG. 1. Other base shapes may be used, and the lenses 246 may be arranged in a more random pattern and/or may have their chords contacting each other or adjacent lenses 246 instead of being spaced apart as shown.

The lenses 246 are used to focus light passing through the material of the concave focusing element and cover/outer layer 248 so as to display images 245 (e.g., 3D images, images with motion, and the like), which are provided via an image element/printed ink on the back or opposite surface of the note 200 and that allow a viewer to verify the authenticity of the bank note 200. As shown in FIG. 2, the bank note 200 includes a first or upper image stack or assembly 220 made up of a first set of ink (and/or other material) layers 222 and a second set of ink (and/or other material) layers 224. A gap or space is provided between the two sets of layers 222, 224, with the optical security assembly 240 with its lenses 246 and outer layer 248 positioned between the two sets of layers 222, 224.

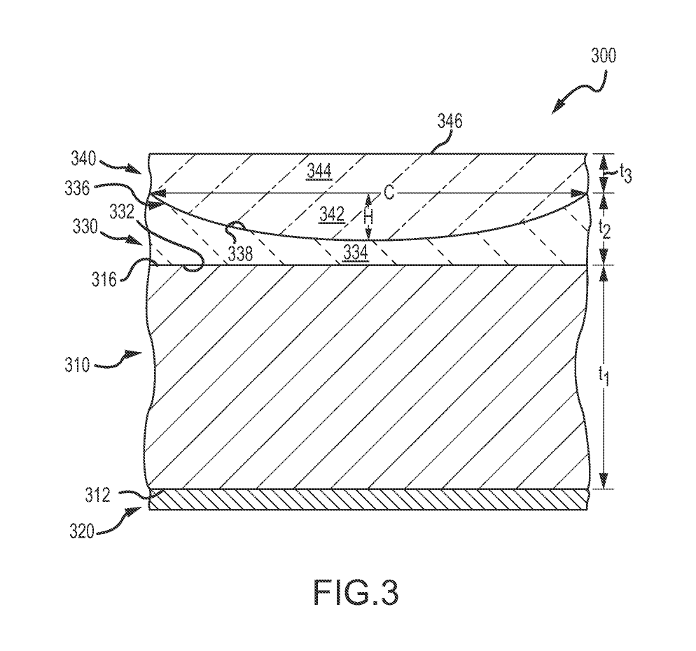

FIG. 3 illustrates a partial sectional view of an optical security element 300 showing layers or components of the element 300 for a single concave lens 336. The concave lens 336 may be a round based (or other shaped base) micro lens or a linear/elongated lens such as a concave lenticule. The optical security element 300 may be provided as an integral part or as an added feature of a product or substrate such as within or on a bank note or piece of currency, within or on a credit/debit/bank card, within or on a product label/tag or other branding item.

The optical security element 300 includes a transparent substrate or body (or carrier film) formed of a material such as a plastic (e.g., a polypropylene) with a first index of refraction and a first thickness, t₁. On a first side/surface 312 of the substrate 310, an image element 320 is provided such as with one or more layers of ink printed onto the surface 312 directly or applied via an adhesive (not shown). On a second side/surface 316 of the substrate 310, a concave focusing element 330 is provided that is configured along with the substrate 310 and the outer layer 340 to focus onto (or in front of or in back of) the image element 320 (e.g., at or near the surface 312 of the substrate 310).

The concave focusing element 330 may be formed on (or later attached to) the second side/surface 316 of the substrate 310 with its base (or first surface) 332 abutting the surface 316 of the substrate 310. A focusing layer/substrate 334 of the focusing element 330 extends outward from the substrate 310 to a thickness, t₂, which is typically much less than the thickness, t₁, of the substrate 310. The material used for the focusing element 330 is chosen to be transparent (e.g., translucent to transparent to light) with a second index of refraction, which may be the same as the first index of refraction of the substrate 310 or that differs (i.e., higher or lower) with some preferred embodiments using a lower index of refraction material for the concave focusing element (e.g., the second index of refraction is less than the first index of refraction). A concave lens 336 is formed upon an exterior or second surface 338 of the concave focusing element 330, and the lens 336 is defined by its chord, C (as measured across the tips/edges of the focusing substrate), its height, H, and its radius, R. These parameters are selected (along with the various refraction indexes) to provide focusing onto the image element 320.

The optical securing element 300 further includes an outer or covering layer 340 formed of a material that is transparent, such as a plastic, ceramic, or the like, and that has a third index of refraction that may be the same as that of the focusing element 330 or that may differ (e.g., the third index of refraction may be lower or higher than the second index of refraction associated with the concave focusing element 330). In some preferred (but not limiting) embodiments of the optical security element 300, the material used for the outer layer 340 is chosen such that the third index of refraction is higher than the second index of refraction. The outer layer 340 is shown to be made up of a fill portion or filler 342 that fills the void or recessed volume of the optical securing element 300 provided by the lens 336 or the surface 338 of the concave focusing element 330. Further, the outer layer 340 optionally includes a covering film 344 with a thickness, t3, (as measured from the lens chord/base to the exterior surface 346) that may be less than the thickness, t2, of the concave focusing element 330 and much less than the thickness, t₁, of the substrate/body 310. The covering film 344 provides a planar outer or exterior surface 346 for the optical security element 300 that is opposite the planar substrate surface 312 upon which the image element 320 is provided.

As will be explained in more detail, the concave focusing element 330 can be manufactured in a number of ways on the carrier film/substrate 310. For example, it can be extruded, cast, or embossed, and the method of manufacture may be selected and configured to facilitate manufacture of the filled-in concave focusing elements 330 in line on a film carrier (e.g., substrate 310), which is part of the optical security element 300. The outer layer 340 with filler 342 may be provided in-line or later with material with a higher index of refraction than the concave focusing element 330. In this way, the lower index structure 330 is applied first on the surface 316 of the film carrier 310 and then its lenses 336 are “filled in” (with material of outer layer 340) in line with, for example, a multiple lens casting process. The range of values for the chord, C, (or diameter) of the lens 336 may vary to practice the element/assembly 300 but often will be provided in the range of 5 to 100 microns. The overall thickness (t₁+t₂+t₃) of the optical securing element 300 may be, in these cases, be in the range of 10 to 200 microns.

The film carrier/substrate 310 in these embodiments may be formed of a material that has an index of refraction that is lower than that of outer layer 340 and even, in some cases, than that of the concave focusing element 330, but in some preferred embodiments will have an index that is higher than that of the concave focusing element 330, e.g., equal to that of the outer layer 340 or in a range between the focusing element 330 and the outer layer 340. In this way, an optical security element 300 can be provided that is a stack of materials going from a higher index material (in outer layer 340) to a lower index material (in concave focusing element 330 with the concave lenses 336 on focusing film/substrate 334) back to a higher index material (in carrier film or substrate 310). This arrangement enhances the focusing ability of the security element 300, e.g., by allowing it to focus with a reduced overall thickness, and the film carrier/substrate 310 is a predesigned (or selected feature) and important part of the optical security element 300 and its focusing (i.e., not a mere spacer).

In some cases, the material used for the carrier film or substrate 310 is chosen such that the first index of refraction is in the range of 1.35 to 1.8. The material (which may be extruded, cast, or embossed upon the substrate 310) used to form the concave focusing element 330 to provide the concave lens 336 may be chosen such that the second index of refraction is in the range of 1.35 to 1.7 (and, in many cases, a value lower than the first index of refraction). Further, to fabricate the optical security assembly 300, the material that is used as the filler 342 and covering film 344 (or for the entire outer or top layer 340) is chosen such that the third index of refraction is in the range of 1.4 to 2.3 (and typically higher than the second index of refraction and matching or higher than the first index of refraction).

The refractive indexes are chosen (and materials with such indexes) can be chosen to provide improved focusing capabilities by carefully establishing differences between the indexes for abutting or adjacent components of the optical security element 300. For example, prototype security elements 300 have been modeled (e.g., with use of ray tracing techniques) that are useful with the index of the materials used in the optical security element 300 such that the difference between the refractive index of the outer layer 340 (and filler 342) and the refractive index of the concave focusing element 330 and lens 336 is at least 0.13 such as a refractive index difference within the range of 0.20 and 0.35. In some cases, the outer layer 340 has an index that is 0.13 to 0.35 higher than the index of the concave focusing element 330.

At this point in the description, it may be useful to further discuss ranges of thicknesses of the components of an optical security element (such as elements 140 of FIG. 1, element 240 of FIG. 2, and element 300 of FIG. 3). This discussion is useful for explaining (or in the context of) the functionality of the optical security element and its components with regard to refractive indices of the materials used in the optical security element (e.g., for the concave focusing element and the layers of material used to fill the concave lenses and provided opposite the array of concave lenses). Many applications or uses of optical security elements described herein are directed toward use in the security industry and anti-counterfeiting efforts and are particularly useful for currency and for currency threads.

As discussed herein, there are number of advantages of a flat lens (or “stealth” lens) where the lens do not have a profile or surfaces that extend outward. This allows the top (or outer surface provided by the outer or top layer) of the optical security element to be glued, varnished, or coated with protective chemistry without negatively affecting the optical security element or its lenses. In addition, there has been evidence that counterfeiters have successfully molded or copied existing security elements with an convex or protruding lens array (with exposed lenses), which facilitates counterfeiting but which cannot be performed with the stealth or covered/filled-in concave lenses of the present optical security elements.

In prior devices, it is common to make flat lenses by casting a convex lens in a high index material and then filling in the lenses with a low index material. However, general material availability limited the effectiveness of maintaining a reasonable focal length with these devices (e.g., would not properly focus on image element or security element has to be quite thick). In other words, lower index materials typically had indices of refraction in the 1.42 to 1.45 range with indices as low as 1.34 being considered an exotic material that may have other negative attributes such as lack of adhesion and high cost (e.g., thousand times more expensive as more traditional materials). The greater the differential in refractive indices the better in many applications as this provides faster focusing that leads to thinner layers and optical security elements, but there are no materials that come close to water or air, which provide high differentials.

For example, a traditional micro lens of about 24 microns that is cast in a traditional material with an index of refraction of 1.6 (or even a more exotic material with an index of refraction of 1.7) and then filled with a material with an index of refraction of 1.43 will provide a 3× focal length. Therefore, if the original desired focal length was about 25 to 30 microns, the focal length will increase to about 75 to 90 microns. Since currency threads generally do not exceed 35 to 40 micron, such optical security elements cannot be used (or will provide ineffective or blurry focusing on an image element). The inventor understood that to “flatten” the lens feature using this approach (of lower index filling a convex lens) and hit the proper or desired focal length, the lens chord must decrease at the same rate as the focal length increases. Hence, in this example, the new lens design would be one third of the original design and would decrease to about 8 microns.

However, the inventor recognized that it would be beneficial to use a concave lens and start with a high index material as the “filler.” Then the optical security element functions such that the light moves through the high index material and is then shaped by the lower index material of the concave focusing element (and its concave lenses). The light then moves into another high index material. Using the same indices of refraction as discussed above in the convex lens example, the focal length of this new optical security element increases by about a factor of 2× rather than 3×. Therefore, the resulting data space under the lens or focusing element is much larger, which makes the graphic element (or image element) larger and easier to generate or provide (e.g., printed, stamped, or the like) on the optical security element. In this way, the image element can include more data and/or have a higher quality in an optical security element, which enhances anti-counterfeiting features of a product including the optical security element. In the above example, the target focal length can be achieved with a 12-micron or slightly larger lens versus the 8-micron lens in the convex implementation. Another ancillary benefit to the concave design is that the upper layer is made of a higher index material that generally will have a better chemical and scratch resistance than a lower index materials (e.g., the outer layer and fillers/fill portions can act as a protective coating for the concave lenses).

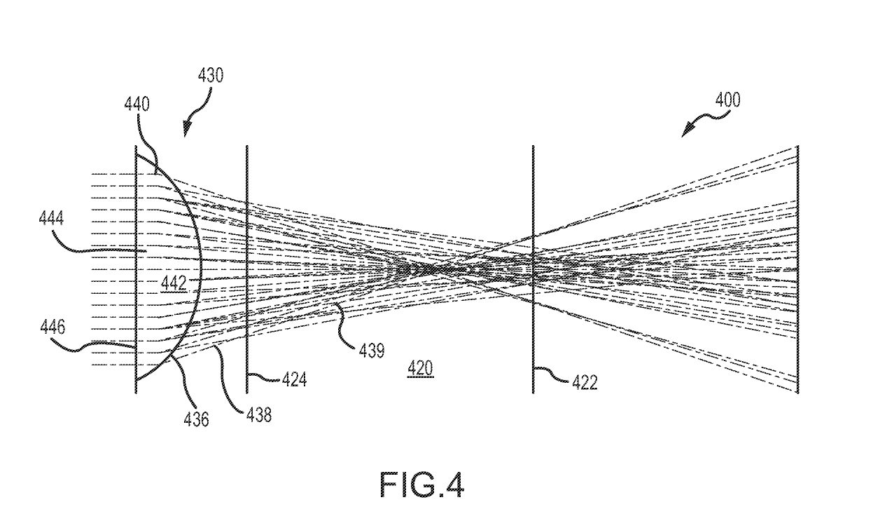

To verify or test the effectiveness of these concepts, a number of models of optical security elements with varying concave focusing elements were created and ray tracing techniques were used to test the focusing capabilities of these models. For example, FIG. 4 shows a ray tracing 400 for one embodiment or prototype/model of an optical security element 410 of the present description. As with the element 300 of FIG. 3, the optical security element 410 includes a film carrier/substrate 420 with a first or bottom surface/side 422 and a second or top surface/side 424. The film carrier's surface/side 422 may be considered the target for focusing as an image element (not shown in FIG. 4) may be provided on this surface/side 422. In this prototype of element 410, the film carrier 420 was formed of a transparent material (e.g., a plastic such as a polypropylene) with an index of refraction of 1.6, and the thickness of the film carrier 420 was 18 microns.

The ray tracing shows effective and useful focusing on the target surface 422. To this end, the optical security element 410 includes a concave focusing element 430 applied to the second or top surface 424 of the carrier film 420. Particularly, the concave focusing element 430 includes a focusing substrate 434 with its base or first surface 438 mated with the surface 424 of the carrier film/substrate 420. A concave lens (or lenses in a more typical focusing element 430) 436 is formed in a top or second surface 439 of the focusing substrate 434. In the prototyped or modeled optical security element 410, the concave focusing element 430 is formed from a material (such as transparent plastic or the like) with an index of refraction of 1.34 (i.e., a lower index material relative to the film carrier or substrate 420 with the difference in indices being 0.26 in this example). The concave lens 436 is formed to have a radius of 5 microns (or −5 microns to indicate concavity) and a chord of 8 microns.

To provide a flat or stealth focusing function, the optical security element 410 further includes an outer or top layer 440 with a filler or fill portion 442 filling the lens 436 (or void or recessed surface provided by each lens 436 in the focusing element 430) and mating with lens or top or second surface 439 of the concave focusing element 430. Further, an additional thickness of material is used to form the outer layer 440 to provide a covering film 444 (e.g., further focusing material and chemical and scratch protection for lens 436).

In the modeled optical security element 410, the outer layer 440 is formed of a transparent material (e.g., a plastic or the like) with an index of refraction of 1.6. In this case, the material of layer 440 is “high index” material relative to the concave focusing element 430 which has an index of refraction of 1.34 (so there is a difference of 0.26). In this modeled optical security element 410, the materials used for the top or outer layer 440 and the film carrier/substrate 420 were the same such that the two indices of refraction match. As shown, the light striking the top surface 446 of the outer layer 440 moves from a higher index material to a lower index material and then back into a higher index material.

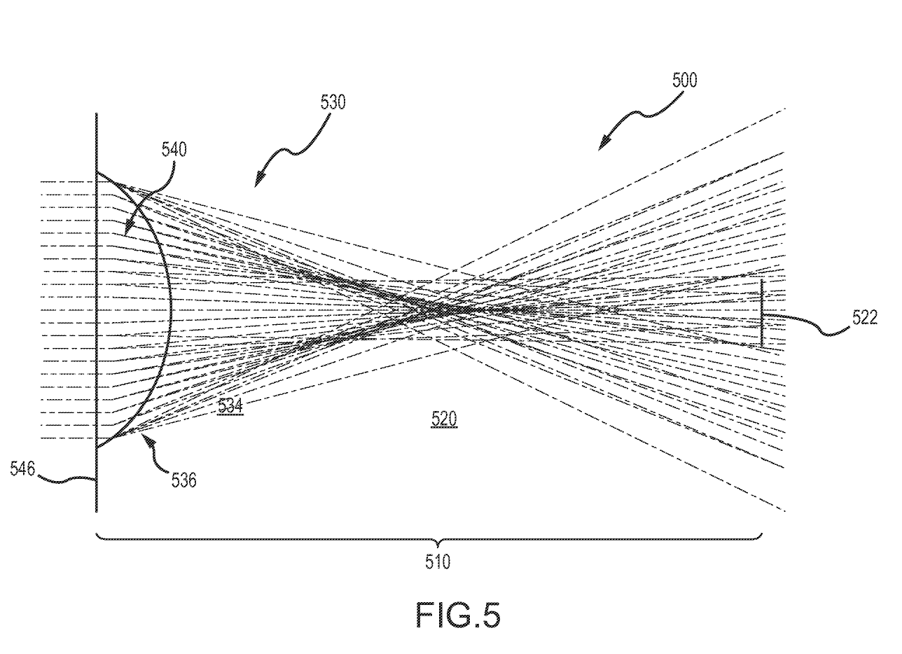

FIG. 5 shows a ray tracing 500 for another embodiment or prototype/model of an optical security element 510 of the present description. As shown, the optical security element 510 includes a film carrier or substrate 520 providing a target or bottom surface 522 for the security element 510. A concave focusing element 530 is formed on this film carrier or substrate 520 with a focusing substrate 534 in which one or more concave lenses 536 are formed. The concave lens 536 is filled in and/or covered with the outer or top layer 540, which provides the planar or flat outer or top surface 546 of the optical security element 510.

As can be seen from the ray tracing 500, focusing onto the target surface 522 is effectively achieved with the optical security element 510 for light striking the top or outer surface 546. While the two optical security elements 410 and 510 of FIGS. 4 and 5 are similar in appearance and design, the element 510 has several differing design parameters than chosen for element 410, which provides the different focusing result as shown in tracings 400 and 500. Specifically, the thickness of the carrier film or substrate 520 is greater than of substrate 420 at 33 microns versus 18 microns. The materials for the various components are chosen to provide high-lower-lowest index light paths, and, to this end, the particular index values were varied from the element 410. Specifically, in the modeled element 510, the index of refraction was highest for the outer layer 540 at 1.6, lower for the concave focusing element's substrate 534 and lens 536 at 1.34, and even lower (lower than the concave focusing element 530 and also lower than the outer layer 540) for the carrier film or substrate at 1.0. The difference in indices was 0.26 between the outer layer 540 and the concave focusing element 530, and the difference in indices between the concave focusing element 530 and the film carrier or substrate is 0.34.

In the concave focusing elements, the lenses may be linear, cylinder lenses (e.g., lenticular), elliptical linear lenses, micro lenses (e.g., hexagonal-based lenses, round-based lenses, square-based lenses, or the like), or any other type of focusing lenses (aspherical or spherical). With each of these lens arrays, though, one of the unique features of the concave focusing element is that it is “stealth” because it has no raised or extending profile as the outer surface is planar or flat due to the filled-in-lens design with the concave lenses creating a focus rather than the typical convex lens arrangement.

The lens design was programmed into a ray tracing program (results shown in FIGS. 4 and 5) with the parameters of the desired focal length and other attributes (e.g., material thicknesses (or thickness goals), viewing angles, desired focus, and indexes of refraction). In some cases, the design was an iterative, manual optimization process, with the desired attributes of the lenses being manipulated and the general result mapped with the ray tracing program. Once the parameters are calculated in the ray tracing program and are found to be in line with the manufacturing process to be used to fabricate the optical security elements, the tools can be created for the concave lenses, such as using diamonds or gray scale lithography using photoresists. The photoresists may be written with laser or electron beam techniques. The tools that will be used in the casting or extrusion processes to form the optical security element can then be manufactured, e.g., as nickel shim masters or engraved cylinders with diamond tools (note, these are generally used for cylindrical versions of the lenses). With these processes, the lenses can be all shapes and sizes such as round, linear or aspherical ellipses, simple spheres, or the like.

As will be understood, a variety of techniques may be used to fabricate the optical security elements of the present description. However, the following discussion provides exemplary techniques that the inventor has found or believes will be useful in producing optical security elements with arrays of concave lenses that are filled in to provide no-profile or flat outer surfaces (e.g., with the lenses being covered or not exposed, which could facilitate copying). The manufacturing process is generally done on a “cast and cure” UV or energy-cured system in a roll-to-roll environment. However, it can be done in sheets in an offset, screen press or gravure press set up. It is desirable to maintain and reproduce the exact lens per the design and maintain the integrity of that design as exactly as possible. Generally speaking, one preferred embodiment is to use a nickel tool or a polymer “belt” as the tool that is precast or extruded with a tool. Then, the method of reproducing the structures on the polymer substrate is to “cure” through the film the structures while they are in contact with the engraved tool so as to get a near perfect replication of the structures. This is commonly done in holography processes.

In this process, the lens structure is a concave structure that sits on top of the substrate made from a convex tool with the structure itself being made of a lower index material, e.g., a material with a refractive index in the range of about 1.3 to about 1.5. During fabrication, the first layer is “cured” though the film while the opposite side has the coating and is formed with pressure to the structures or the tool. This process leaves a convex structure that looks generally like a small “cup” that can then be filled in the next step of the fabrication or manufacturing process.

The next layer, which is the “fill in” layer (or outer layer with fill portions or fillers) can be a higher index material, with an index of refraction between about 1.55 and about 1.9 and with some commonly available and useful materials having indices in the range of about 1.6 to about 1.75. These materials are available from companies like Ashland Chemicals or Sun Chemicals. They may be designed to cure with light (e.g., light emitting diodes (LEDs)) in the wavelengths between 350 and 400 nanometers or with a more broadband UV spectrum from about 300 nm to over 1000 nm. The materials can also be designed to energy cure with electron beam. The “fill in” or outer layer fills in the structures (e.g., fills in the void or recessed surfaces defining each of the concave lenses in the concave focusing element) and may be performed such that the outer layer has very little excess material on the top (e.g., the covering film shown in the figures may be quite thin such as 0 to several microns thick).

The film portion is generally PET film, but it could also be polypropylene, polyethylene, or any type of clear film. While PET is the preferred film because of its slightly higher refractive index of about 1.55-1.58, any film can be used. The appropriate refractive index is then programmed into the ray tracing software, and the appropriate thicknesses of the other layer/components are achieved as a result of the output of the ray tracing program. Any of the mapping systems for pixels can be used in the process (slant, matrix or even straight lenticular imaging) to provide the image element of an optical security element, and these pixels can then be provided by printing onto a substrate or carrier film target surface (the back or bottom surface/side of the optical security element).

In another embodiment, the film itself can be the top layer, and the micro-lens can be the lower layer or be provided in the lower layer. In such an embodiment, the optical security element would have the opposite of the structure used on the top located lens embodiment, and the tool could be a concave tool providing a convex lens shape on the bottom of the film. In this case, the convex lens structure on the bottom is also made of a low index and then filled with a high index material to achieve the desired focus and thickness.

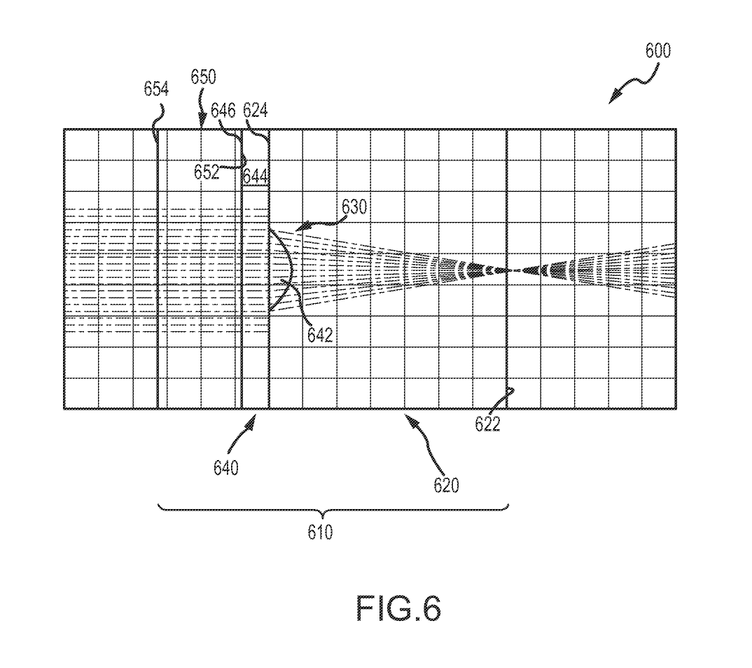

This alternative embodiment was modeled as shown with the ray tracing 600 for the optical security element 610 shown in FIG. 6. Focusing is shown to be provide accurately on the target or back surface 622 of the security element 610. To this end, the security element 610 includes a film or substrate 620 with the target or first surface 622. The film or substrate is formed of a material with a lower (relatively) index of refraction such as about 1.45 and a desired thickness such as about 35 microns. In contrast to the other designs, the top or second surface 624 of the film or substrate 620 is not wholly planar as this surface 624 is configured to provide one or more concave lenses 630 (e.g., to provide the concave focusing element of the security element 610). In this modeled embodiment, the lens was defined by a chord of 13 microns.

The optical security element 610 includes a fill-in layer 640 with a fill portion or filler 642 filling the convex lens 642 as well as providing a covering film 644 with a thickness, in this example, of 4 microns. The fill-in layer 640 in the modeled element 610 is chosen to have an index of refraction that is greater than that of the substrate 620 and its lenses 630 such as with an index of 1.71 (for a difference of 0.26). In this way, the convex focusing element provided by lens 630 in surface 624 is again formed of a lower index material and filled in with a higher index material. The fill-in layer 640 provides an upper surface/side 646 opposite the lens 642 that is flat or planar, and this surface 646 may be the outer surface of the security element 610 in some embodiments.

Alternatively, as shown, an additional focusing and/or protective layer 650 may be applied over the fill-in layer 640, and this layer may be formed with a surface/side 652 contacting the fill-in surface or side 646. Further, the layer 650 includes a second or exterior surface or side 654 opposite the surface/side 652 that is flat or planar. The layer 650 may have a range of thicknesses to practice the element 610 such as 12.5 microns as modeled in tracing 600, and the layer 650 may be formed of a material with a range of indices of refraction with the modeled element 610 using a layer 650 with a refractive index of 1.55, which is lower than that of fill-in layer 640 (difference of 0.16) but that is higher than the film or substrate 620 providing the lens 630.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

Generally, and as discussed above, one useful method of manufacture is to UV “cast” the convex lenses or structures on a film carrier, which has been carefully chosen for its attributes of strength, clarity, and refractive index (as it is also a part of the focusing components of the optical security element). The concave structures or lenses are cast on a manufacturing line (or casting line) and can be cured while in contact with the belt or cylinder or plate so as to retain a perfect or nearly perfect replication of the structures/lenses with the energy-cured polymer (e.g., material with a lower index of refraction than the material used to fill-in the structures/lenses). Since the structures are more fragile than a convex lens structure (used in conventional security features), one useful method of manufacturing is to immediately cast and cure the flat layer “in line” in a separate unit, filling in the concave structure with the higher index material.

Each of the layers mirrors the program data (e.g., from ray tracing routines) and has a predetermined thickness including the anchor coat for the lower index layer, as well as the higher index “filler” and extra material over the lower index structures. All of these thickness are kept in the range of manufacturing tolerance and predetermined in the software program so as to mirror the desired data from the program in order for the focusing element to work properly.

Of special note, is that the high-to-low to high index combination of elements is especially unique as the carrier film and the index chosen is an important part of the focusing element and will continue to shape and focus the light as the light moves into the final index (the film itself). By moving from the lower index into the higher index the light focuses more rapidly than if the carrier has the same index as the concave structure. While in one embodiment the film layer can be of the same index as the concave focusing element (or less), the required thickness of the overall lens will be greater than if the film element has a higher index of refraction.

Another unique attribute of the lens construction is that it can use a high index material as the top layer (flat fill-in layer) followed by the shape of the lens molded in concave within a lower index layer. The carrier or substrate does not act as just a spacer in many embodiments as it is a higher index layer that helps provide the focus of the lens and is in fact a focusing element in some of the embodiments of the invention. The three indices of refraction, when combined, can increase the power of the focus of the lens and, therefore, decrease the necessary focal length or chord width of the lens as compared to a traditional convex lens (which are typically made of a high index material and “filled in” with a lower index material on top to achieve a flat surface).

The benefit of this construction is that when compared to the traditional flat lens formed with a high index convex lens and a lower index filling element, the concave version of the lens achieves about a thirty-percent reduction in focal length given the same chord width, allowing more data due to a wider chord width relative to the desired focal length. This is particularly important in currency threads and other security labeling applications where cost and thickness are important (e.g., where it is desirable to reduce costs and to minimize or at least reduce overall thickness of the security element or match its thickness to the body of the product (e.g., currency or bank note) when provided as an integral feature).

I claim:

1. An apparatus for use as an optical security element, comprising:
a planar substrate with a first side and a second side opposite the first side, wherein the planar substrate comprises a transparent material with a first index of refraction;
an image element provided on the first side of the planar substrate;
a concave focusing element with a focusing substrate with a first side abutting the second side of the planar substrate and with a second side comprising a plurality of concave lenses, wherein the concave focusing element comprises a transparent material with a second index of refraction; and
an outer layer comprising fill portions filling the concave lenses and further comprising a covering film over the fill portions, wherein the outer layer comprises a transparent material with a third index of refraction, wherein light striking a planar exterior surface of the covering film is focused through the outer layer, the concave lenses, and the planar substrate onto the image element.

2. The apparatus of claim 1, wherein the second index of refraction is lower than the third index of refraction.

3. The apparatus of claim 2, wherein the first index of refraction matches the third index of refraction.

4. The apparatus of claim 2, wherein the first index of refraction is lower than the second index of refraction.

5. The apparatus of claim 2, wherein the first index of refraction is in the range of 1.35 to 1.8.

6. The apparatus of claim 5, wherein the first index of refraction is 1.6.

7. The apparatus of claim 2, wherein the second index of refraction is in the range of 1.34 to 1.7.

8. The apparatus of claim 7, wherein the second index of refraction is less than 1.5 and the lenses each have a chord width and a radius of less than 10 microns.

9. The apparatus of claim 2, wherein the third index of refraction is in the range of 1.4 to 2.3.

10. The apparatus of claim 9, wherein the third index of refraction is 1.6.

11. The apparatus of claim 1, wherein the second index of refraction is lower than the third index of refraction by at least 0.13.

12. The apparatus of claim 11, wherein the second index of refraction is lower than the third index of refraction by an amount in the range of 0.20 and 0.35.

13. The apparatus of claim 1, wherein each of the lenses has a chord width in the range of 5 to 100 microns and wherein the third index of refraction is higher than the second index of diffraction by at least 0.13.

14. The apparatus of claim 1, wherein a combined thickness of the planar substrate, the concave focusing element, and the outer layer is between 10 and 200 microns.

15. An apparatus for use as a polymer bank note or other product, comprising:
a transparent substrate;
an image element applied to a first side of the transparent substrate;
a plurality of concave structures formed in a second side of the transparent substrate opposite the image element; and
a filler layer covering at least a portion of the second side of the transparent substrate and filling the concave structures with transparent material with an index of refraction higher than an index of refraction of the transparent substrate, wherein light striking a planar surface of the filler layer provided opposite the concave structures moves through the filler layer, the concave structures, and the transparent substrate to be focused on the image element.

16. The apparatus of claim 15, further comprising a focusing layer on the planar surface of the filler layer, wherein the focusing layer is formed of transparent material having an index of refraction lower than the material of the filler layer.

17. The apparatus of claim 15, wherein the index of refraction of the filler layer is in the range of 1.4 to 2.3 and the index of refraction of the transparent substrate is in the range of 1.34 to 1.8.

18. The apparatus of claim 15, wherein the index of refraction of the filler layer is greater than the index of refraction of the transparent substrate by at least 0.13.

19. The apparatus of claim 15, wherein the transparent substrate and the filler layer have a combined thickness of less than 50 microns.

20. A method of manufacturing an optical security element, comprising:
providing a film of a first transparent material having a first index of refraction;
applying a layer of a second transparent material having a second index of refraction on a surface of the film, wherein the applying includes forming a plurality of concave lenses facing away from the film; and
filling in the concave lenses with a third transparent material having a third index of refraction that is higher than the second index of refraction, wherein the first, second, and third indices of refraction and parameters of the concave lenses are selected whereby light is focused through the third transparent material, the concave lenses and second transparent material, and the film of the first transparent material onto a focus target.

21. The method of claim 20, wherein the third index of refraction differs from the second index of refraction by at least 0.13.

22. The apparatus of claim 21, wherein the third index of refraction differs from the second index of refraction by an amount in the range of 0.20 and 0.35.

23. The apparatus of claim 20, wherein the first index of refraction is in the range of 1.0 to 1.8, the second index of refraction is in the range of 1.34 to 1.7, and the third index of refraction is in the range of 1.4 to 2.3.

24. The apparatus of claim 20, wherein the forming of the plurality of concave lenses includes casting or embossing concave structures.
